(19) United States
(12) Patent Application Publication
(10) Pub. No.: US 2013/0190012 A1
(43) Pub. Date: Jul. 25, 2013

(54) MOBILE STATION DIRECTED TO WIRELESS COMMUNICATION SYSTEM INCLUDING HOME CELL

(71) Applicants: Koki Suzuki, Osaka-shi (JP); Shinichi Sawada, Osaka-shi (JP); Hirokazu Kobayashi, Osaka-shi (JP); Shigeto Suzuki, Osaka-shi (JP); Akio Yoshihara, Osaka-shi (JP)

(72) Inventors: Koki Suzuki, Osaka-shi (JP); Shinichi Sawada, Osaka-shi (JP); Hirokazu Kobayashi, Osaka-shi (JP); Shigeto Suzuki, Osaka-shi (JP); Akio Yoshihara, Osaka-shi (JP)

(73) Assignee: SHARP KABUSHIKI KAISHA, Osaka-shi, Osaka (JP)

(21) Appl. No.: 13/876,860

(22) PCT Filed: Sep. 30, 2011
(86) PCT No.: PCT/JP2011/072581

§ 371 Date: Mar. 29, 2013

(30) Foreign Application Priority Data
Sep. 30, 2010 (JP) 2010-220209

(51) Int. Cl. H04W 64/00

(52) U.S. Cl. CPC H04W 64/00
USPC 455/456.1

(57) ABSTRACT

A mobile station connected to a wireless communication network includes a surrounding environment recording unit configured to record a surrounding environment of the mobile station; a proximity determination unit; and a proximity indication generation unit configured to generate a proximity indication. The proximity determination unit compares a past surrounding environment record that has been recorded by the surrounding environment recording unit with the current surrounding environment record. When the surrounding environment records correspond to each other, or when a degree of similarity between the surrounding environment records exceeds a predetermined degree, the proximity determination unit determines that the mobile station is in proximity to a predetermined home cell base station, and transmits the proximity indication generated by the proximity indication generating unit to a macro cell base station in response to determination that the mobile station is in proximity to the predetermined home cell base station.

### TECHNICAL FIELD

The present invention relates to a mobile station directed to a wireless communication system including a home cell.

### BACKGROUND ART

For a recent wireless communication system, a home cell (Home NodeB and/or Home eNodeB) providing service in a narrower range and service only for particular users is proposed, in addition to a conventional macro cell having a wider coverage area. Studies have been conducted for implementation of a home cell also in 3 GPP E-UTRA (The 3rd Generation Partnership Project Evolved Universal Terrestrial Radio Access).

For implementation of a home cell in 3 GPP E-UTRA, access (connection) configuration for a mobile station device (a mobile station) to connect to a home cell has been studied, and the following three solutions are proposed, including (1) open access, (2) hybrid access, and (3) closed access. Open access is a configuration that allows access by any subscriber as in the case of a macro cell. Hybrid access is a configuration that allows access by both of a subscriber belonging to a CSG (Closed Subscriber Group) and a subscriber not belonging to the CSG. Examples of the closed subscriber group in this case may be an employee in a company, a user in facilities, a family member in a household, and the like. Closed access is a configuration that allows access only by a subscriber belonging to the CSG. Furthermore, the home cell configured as a hybrid access is referred to as a hybrid cell, and the home cell configured as a closed access is referred to as a CSG cell.

Non-Patent Literature (NPL) 1 discloses a handover process for implementing a transition of a base station having coverage in which a mobile station is located. In 10.5.1 Inbound mobility to CSG cells, NPL 1 discloses a handover process in which a mobile station located in the coverage of a macro cell base station shifts to a cell coverage of a home cell base station such as a hybrid cell and a CSG cell. In 10.5.2 Outbound mobility from CSG cells, NPL 1 also discloses a handover process in which a mobile station located in the coverage of a home cell base station such as a hybrid cell and a CSG cell shifts to a cell coverage of a macro cell base station. The process for handover of a base station having coverage in which a mobile station is located from a macro cell base station to a home cell base station is referred to as “inbound handover”. The process for handover of a base station having coverage in which a mobile station is located from a home cell base station to a macro cell base station is referred to as “outbound handover”. In addition, the process for handover from a macro cell base station in which a mobile station is located to cell coverage of another macro cell base station is simply referred to as “handover” unless otherwise specified.

### CITATION LIST

### Non Patent Literature

NPL 1: 3GPP TS (Technical Specification) 36.300, V10.0.0 (2010-06), Evolved Universal Terrestrial Radio Access (E-UTRA) and Evolved Universal Terrestrial Radio Access Network (E-UTRAN), Overall description Stage2 (Release 10)

### SUMMARY OF INVENTION

### Technical Problem

In order to perform inbound handover from a macro cell to a home cell according to the procedure disclosed in NPL 1, a mobile station needs to measure a home cell. When measuring a home cell, if a home cell base station communicates at the same frequency as that of a macro cell base station of the macro cell having coverage in which the mobile station is located, the inbound handover processes and the process related thereto can be performed easily. On the other hand, if the home cell base station communicates at a frequency different from that of the macro cell base station of the macro cell having coverage in which the mobile station is located, the mobile station cannot identify a home cell. Accordingly, the mobile station needs to search a home cell. This process for searching a home cell may cause increased traffic, thereby deteriorating the communication performance of the entire communication system.

The present invention has been made in light of the above-described circumstances, and an object of the present invention is to provide a mobile station that allows further stabilization of a communication system.

### Solution to Problem

According to an embodiment, a mobile station connected to a wireless communication network is provided. The mobile station includes surrounding environment recording means for recording a surrounding environment of the mobile station; proximity determining means for determining whether the mobile station is in proximity to a predetermined base station; and proximity indication generating means for generating a proximity indication. The proximity determining means compares a past surrounding environment record that has been recorded by the surrounding environment recording means with a current surrounding environment record. When the surrounding environment records correspond to each other, or when a degree of similarity between the surrounding environment records exceeds a predetermined degree, the proximity determining means determines that the mobile station is in proximity to a predetermined home cell base station, and transmits the proximity indication generated by the proximity indication generating means to a macro cell base station in response to determination that the mobile station is in proximity to the predetermined home cell base station.

According to an embodiment, a mobile station connected to a communication network in which both a macro cell base station and a home cell base station exist is provided. The mobile station includes surrounding environment recording means for recording a surrounding environment of the mobile station; in-cell-coverage history recording means for recording a history of a macro cell base station and a home cell base station each having coverage in which the mobile station was/is located; proximity determining means for determining whether the mobile station is in proximity to a predetermined home cell base station; and proximity indication generating means for generating a proximity indication. The proximity determining means compares a past in-cell-coverage history and a past surrounding environment record in execution of inbound handover that are recorded by the in-cell-coverage history recording means and the surrounding environment recording means, with a current in-cell-coverage history and a current surrounding environment record, respectively. When the in-cell-coverage histories correspond to each other and the surrounding environment records correspond to each other, the proximity determining means determines that the mobile station is in proximity to the predetermined home cell base station, and transmits the proximity indication generated by the proximity indication generating means to the macro cell base station in response to determination that the mobile station is in proximity to the predetermined home cell base station.

Preferably, the surrounding environment record includes at least one selected from a PCI (Physical Cell Identity), a CGI (Cell Global Identifier), electric field strength, and a frequency.

Further preferably, when the electric field strength is lower than pre-set strength, the proximity determining means stops transmission of the proximity indication.

Preferably, the in-cell-coverage history includes a receiving history of a synchronous signal and/or indication information.

Preferably, the proximity determining means compares the in-cell-coverage histories using a part or all of one or more cells recorded by the in-cell-coverage history recording means.

### Advantageous Effects of Invention

According to the present invention, a communications system can be further stabilized.

### BRIEF DESCRIPTION OF DRAWINGS

FIG. 1 is a schematic configuration diagram of a mobile station according to a first embodiment of the present invention.

FIG. 2 is a schematic diagram of a wireless communication system according to the first embodiment of the present invention.

FIG. 3 is a flow diagram showing the procedure of the first inbound handover performed for the mobile station according to the first embodiment of the present invention.

FIG. 4 is an example of a surrounding environment record in execution of inbound handover for the mobile station according to the first embodiment of the present invention.

FIG. 5 is a flow diagram showing the procedure of the second and subsequent inbound handovers performed for the mobile station according to the first embodiment of the present invention.

FIG. 6 is a flow diagram showing the procedure related to selection between the first inbound handover process and the second and subsequent inbound handover processes performed for the mobile station according to the first embodiment of the present invention.

FIG. 7 is an example of an in-cell-coverage history record in execution of inbound handover according to the second embodiment of the present invention.

FIG. 8 is a flow diagram showing the procedure of the second and subsequent inbound handovers performed for the mobile station according to the second embodiment of the present invention.

FIG. 9 is a diagram for illustrating inbound handover according to the related art.

### DESCRIPTION OF EMBODIMENTS

The embodiments of the present invention will be hereinafter described in detail with reference to the accompanying drawings, in which the same or corresponding components are designated by the same reference characters, and description thereof will not be repeated. The present invention is not limited to the embodiments described later, and executable in various manners within the scope without deviating from the intention.

<Terms>

In the present specification, the process of performing handover of a base station having coverage in which a mobile station is located from a macro cell base station to a home cell base station is referred to as “inbound handover”. The process of performing handover of a base station having coverage in which a mobile station is located from a home cell base station to a macro cell base station is referred to as “outbound handover”. The process of performing handover of a base station having coverage in which a mobile station is located from a macro cell base station having coverage in which the base station is located to another macro cell base station is simply referred to as “handover”.

Also, in the present specification, a small-sized communication base station device that provides a cell (communication range) smaller than that of a macro cell base station is referred to as a “home cell base station”. This home cell base station typically includes Home NodeB, Home eNodeB and the like that are specified under 3 GPP E-UTRA, and particularly, a hybrid cell and a CSG cell are conceived.

<Related Art>

As a related art according to the embodiment of the present invention, the procedure of inbound handover disclosed in NPL 1 will be hereinafter described.

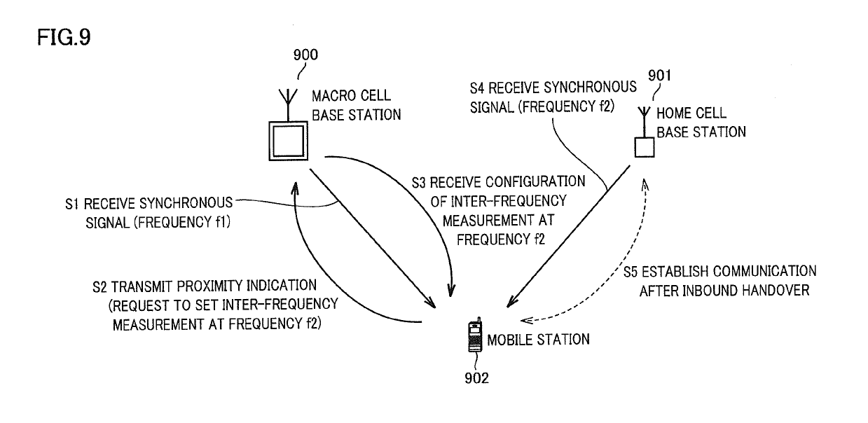

Inbound handover requires a preparation (preliminary preparation) before execution of handover as compared with handover or outbound handover. Referring to FIG. 9, the preliminary preparation for inbound handover will be described.

It is assumed that a mobile station 902 communicates with a macro cell base station 900 at a frequency f1 (step S1 in FIG. 9). In this circumstance, mobile station 902 is preliminarily preparing to undergo inbound handover to a home cell base station 901 communicating at a frequency f2. When performing handover to a base station using a frequency different from the frequency used by the base station that is being communicating with the mobile station, the mobile station should perform quality measurement of a communication link for this different frequency, that is, inter-frequency measurement, before handover. In order to perform the inter-frequency measurement, mobile station 902 transmits a proximity indication requesting a configuration of inter-frequency measurement to macro cell base station 900 (step S2 in FIG. 9). The proximity indication includes a configuration for measuring the radio link quality of a communication frequency f2 of home cell base station 901. When receiving the proximity indication, macro cell base station 900 transmits the configuration of inter-frequency measurement (step S3 in FIG. 9). By implementing the configuration of the inter-frequency measurement received from home cell base station 901, mobile station 902 becomes able to receive a synchronous signal (frequency f2) of home cell base station 901 (step S4 in FIG. 9). Then, mobile station 902 measures the quality of the radio link, performs an inbound handover process, and establishes communication with home cell base station 901 (step S5 in FIG. 9).

As described above, in order to perform inbound handover from a macro cell to a home cell, a mobile station has to measure a home cell. Accordingly, a proximity indication, configurations for each measurement and the like are transmitted and received between the mobile station and the home cell base station. When the home cell base station communicates at the same frequency as that of the macro cell base station, the mobile station located in coverage of a macro cell can receive a synchronous signal transmitted from the home cell base station, and therefore, measurement of the communication link quality, an inbound handover process and the like can be readily performed. However, when the home cell base station communicates at a frequency different from that of the macro cell base station, the mobile station cannot identify a home cell, and therefore, it is necessary to search a home cell. In order to search a home cell, it is necessary to repeat the process of transmitting a proximity indication to macro cell base station 900 (step S2 in FIG. 9) and the process of transmitting the configuration of inter-frequency measurement (step S3 in FIG. 9) while changing the frequency configuration until the synchronous signal of home cell base station 901 can be received. This leads to an increase in upstream traffic due to increased transmission of proximity indications and also to an increase in downstream traffic due to increased transmission of configurations of each measurement. Consequently, the communication performance of the entire communication system may be deteriorated.

<Outline>

In consideration of the related art as described above, the mobile station according to the embodiment of the present invention compares the past surrounding environment record in execution of the inbound handover with the current surrounding environment record, and transmits an appropriate proximity indication to a macro cell. By employing such an arrangement of the mobile station, the communications system is further stabilized.

Furthermore, by efficiently transmitting a proximity indication in execution of inbound handover, deterioration in performance of the communication system can be avoided while the electric power consumed by the mobile station can be reduced.

### First Embodiment

In the first embodiment of the present invention, based on the synchronous signal and/or indication information transmitted from the macro cell base station and/or the home cell base station, the mobile station records the information showing the receiving status at the location where the mobile station exists, such as a frequency, electric field strength and an identifier of the base station, as a surrounding environment record. When the second and subsequent handovers are performed, the mobile station uses the surrounding environment record in execution of the first inbound handover, to perform proximity determination. Based on the result of this proximity determination, the mobile station efficiently transmits a proximity indication to the macro cell base station.

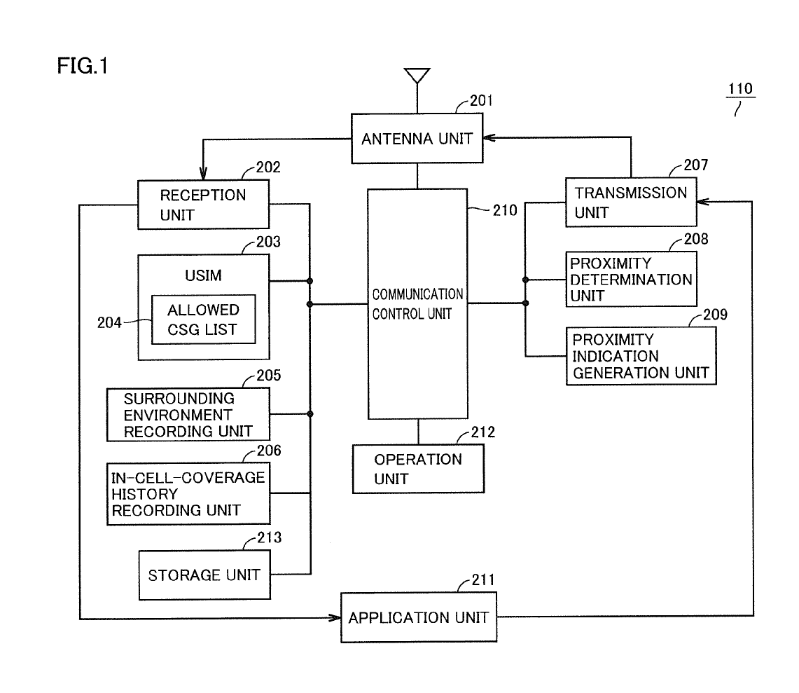

FIG. 1 is a schematic configuration diagram of a mobile station 110 according to the first embodiment of the present invention. Referring to FIG. 1, mobile station 110 includes, as main components, an antenna unit 201, a reception unit 202, a USIM (Universal Subscriber Identity Module) 203, an allowed CSG list 204 stored in USIM 203, a surrounding environment recording unit 205, an in-cell-coverage history recording unit 206, a transmission unit 207, a proximity determination unit 208, a proximity indication generation unit 209, a communication control unit 210, an application unit 211, an operation unit 212, and a storage unit 213.

Antenna unit 201 transmits a radio signal from transmission unit 207 to a base station, and also, receives a radio signal from the base station and outputs the received signal to reception unit 202.

Reception unit 202 receives the signal from the base station through antenna unit 201, reads the received data including an identifier of the base station such as a PCI (Physical Cell Identity) and a CGI (Cell Global Identifier) from the received signal, and outputs the data to communication control unit 210, application unit 211 and the like. Furthermore, reception unit 202 calculates electric field strength of the signal received from each base station, and outputs the calculated electric field strength to communication control unit 210.

Communication control unit 210 receives the received data including an identifier of the base station such as a PCI and a CGI and electric field strength from reception unit 202, and records (stores) the same in USIM 203, surrounding environment recording unit 205, in-cell-coverage history recording unit 206, storage unit 213, and the like.

Surrounding environment recording unit 205 mainly records (stores) a PCI, a CGI, electric field strength of the received signal, a frequency, and the like.

In-cell-coverage history recording unit 206 records the history of the base station having coverage in which mobile station 110 is located. The cell recorded in in-cell-coverage history recording unit 206 is associated with the surrounding environment record stored in surrounding environment recording unit 205. Communication control unit 210 can read out the cell recorded in the in-cell-coverage history and the surrounding environment record of this cell.

When the weather changes or when the mobile station itself moves to cause a change in the communication state, the mobile station may shift a base station with which it communicates (handover is performed). When handover is performed to cause the mobile station to be located in the coverage of another cell, communication control unit 210 records a cell having coverage in which the mobile station is located, as a history, in in-cell-coverage history recording unit 206. Recording of a surrounding environment in surrounding environment recording unit 205 and recording of a cell in in-cell-coverage history recording unit 206 may be performed even if the mobile station is not located in new coverage. In other words, also in the case where handover is tried to be performed and a synchronous signal and/or indication information has been received from the base station to which handover is performed but handover is eventually not performed, the PCI, the CGI, the electric field strength of the received signal, the frequency and the like measured from the synchronous signal and/or indication information may be recorded in surrounding environment recording unit 205 while the corresponding cell may be recorded in in-cell-coverage history recording unit 206.

Proximity determination unit 208 compares one or more surrounding environments recorded in surrounding environment recording unit 205 when inbound handover was performed in the past or when inbound handover was tried to be performed with the surrounding environment currently recorded in surrounding environment recording unit 205, to determine which surrounding environment among the past records recorded in surrounding environment recording unit 205 corresponds to the current surrounding environment of the mobile station. Communication control unit 210 transmits the result obtained from proximity determination unit 208 to proximity indication generation unit 209, and instructs generation of a proximity indication that is to be transmitted to the base station. According to the instruction from communication control unit 210, proximity indication generation unit 209 generates a proximity indication including a configuration of inter-frequency measurement and a configuration of intra-frequency measurement from the surrounding environment record corresponding to the current surrounding environment of the mobile station that is determined by proximity determination unit 208. Communication control unit 210 obtains the proximity indication generated by proximity indication generation unit 209, and sends this proximity indication to transmission unit 207. Transmission unit 207 transmits the proximity indication received from communication control unit 210 to the base station through antenna unit 201.

In other words, the proximity determination in the first embodiment corresponds to the process for performing inbound handover to determine whether the mobile station comes close to the home cell to which the mobile station aims to be connected. Generation and transmission of a proximity indication correspond to a pre-process for performing inbound handover.

Application unit 211, for example, performs processes for a user interface, browsing, e-mail and the like, and outputs transmit data such as outgoing e-mail to transmission unit 207. Transmission unit 207 transmits the data output from application unit 211 through antenna unit 201 to the base station having coverage in which the mobile station is located.

USIM 203 stores the user's telephone number, the information of the mobile phone service provider with which the user contracts, and the like. Allowed CSG list 204 is a list recording a home cell base station configured as a closed access. By equipping USIM 203 including allowed CSG list 204, mobile station 110 can communicate with the CSG cell recorded in allowed CSG list 204. In addition, allowed CSG list 204 does not have to be provided within USIM 203, but may be provided in storage unit 213.

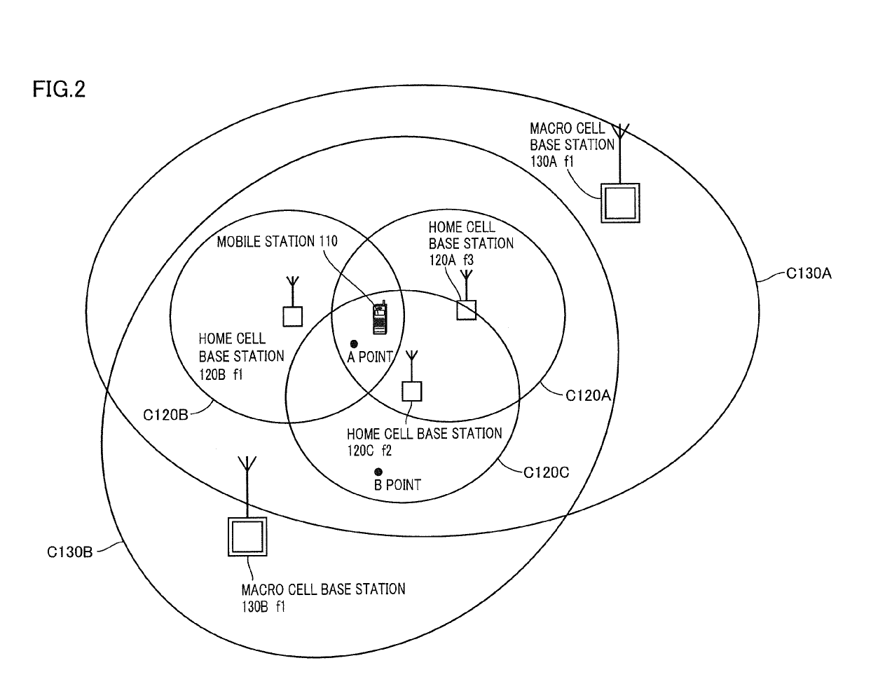

FIG. 2 is a schematic diagram of a wireless communication system according to the first embodiment of the present invention. FIG. 2 shows a situation where inbound handover may be performed. The wireless communication system shown in FIG. 2 includes mobile station 110, home cell base stations 120A, 120B and 120C, and macro cell base stations 130A and 130B. Mobile station 110 is a mobile station device such as a mobile phone terminal and an information communication terminal. The line surrounding each base station exemplifies the range in which a radio wave of each base station can reach, that is, the range (cell range) in which service can be provided. In this example, the cell ranges of home cell base stations 120A, 120B and 120C correspond to C120A, C120B and C120C, respectively, while the cell ranges of macro cell base stations 130A and 130B correspond to C130A and C130B, respectively.

In FIG. 2, mobile station 110 is located at an A point, and located in the coverage of macro cell base station 130A. The information about predetermined home cell base station 120A is recorded in allowed CSG list 204 of USIM 203 in mobile station 110. The user of mobile station 110 is assumed to desire implementation of inbound handover from macro cell base station 130A to home cell base station 120A in order to use a service specific to a home cell. In this case, the communication frequency of each of macro cell base stations 130A and 130B and home cell base station 120B is f1; the communication frequency of home cell base station 120C is f2; and the communication frequency of home cell base station 120A is f3.

Then, handover performed in the situation in FIG. 2 will be described. Mobile station 110 can receive a synchronous signal from the base station communicating at the same frequency as that used by mobile station 110 even if it is not located in the coverage of this base station. Accordingly, mobile station 110 can receive a synchronous signal from each of macro cell base station 130B and home cell base station 120B. In such a situation, when handover is performed from macro cell base station 130A to macro cell base station 130B, or from macro cell base station 130A to home cell base station 120B, that is, when handover to the base station communicating at the same frequency f1 is performed, mobile station 110 does not have to transmit a proximity indication such as inbound handover to the home cell communicating at a different frequency.

Furthermore, an example in the situation shown in FIG. 2 will be hereinafter described, in which outbound handover to macro cell base station 130A is tried to be performed in the state where mobile station 110 is located in the coverage of home cell base station 120C. In this case, in the stage where mobile station 110 is located in the coverage of home cell base station 120C in which the communication frequency is f2, the synchronous signal (frequency f1) of macro cell base station 130A communicating at a different frequency cannot be received, but it is possible to know communication frequency f1 of adjacent macro cell base station 130A through the communication with home cell base station 120C. Accordingly, mobile station 110 does not have to transmit a proximity indication even during execution of outbound handover.

Furthermore, in the situation where mobile station 110 is located in the coverage of macro cell base station 130A and macro cell base station 130B communicates at a frequency different from that of mobile station 110, also when mobile station 110 implements handover from macro cell base station 130A to macro cell base station 130B, mobile station 110 can know the communication frequency of macro cell base station 130B from macro cell base station 130A having coverage in which mobile station 110 is located. Therefore, mobile station 110 does not have to transmit a proximity indication.

However, when mobile station 110 is located in the coverage of macro cell base station 130A communicating at frequency f1 and when inbound handover to home cell base station 120A communicating at frequency f3 is performed, mobile station 110 cannot receive a synchronous signal output from home cell base station 120A and cannot know the communication frequency of home cell base station 120A. In such a case, in order to perform inbound handover by the procedure according to the related art, mobile station 110 has to transmit, to macro cell base station 130A having coverage in which mobile station 110 is located, a proximity indication to give an instruction to transmit to mobile station 110 a configuration of inter-frequency measurement at frequency f3 that is a communication frequency of home cell base station 120A. This is because since the configuration of inter-frequency measurement includes a configuration for changing the frequency into f3 to search a surrounding base station, the configuration of inter-frequency measurement is implemented, thereby allowing reception of a synchronous signal of home cell base station 120A communicating at a different frequency. Mobile station 110 receives the synchronous signal of frequency f3, measures the quality of the communication link, and undergoes inbound handover, thereby being located in the coverage of home cell base station 120A.

However, mobile station 110 does not know that home cell base station 120A communicates at frequency f3. Accordingly, until for example the user selects frequency f3 at which home cell base station 120A can be identified, mobile station 110 has to randomly make a frequency configuration and continue to transmit a proximity indication to a macro cell base station. Therefore, needless load is to be exerted onto a communication system. In the first embodiment, an object is to reduce such needless transmission of a proximity indication. Specifically, mobile station 110 records the environment information in execution of the first inbound handover. Then, from the subsequent execution of inbound handover, inbound handover is efficiently performed by using the recorded environment information.

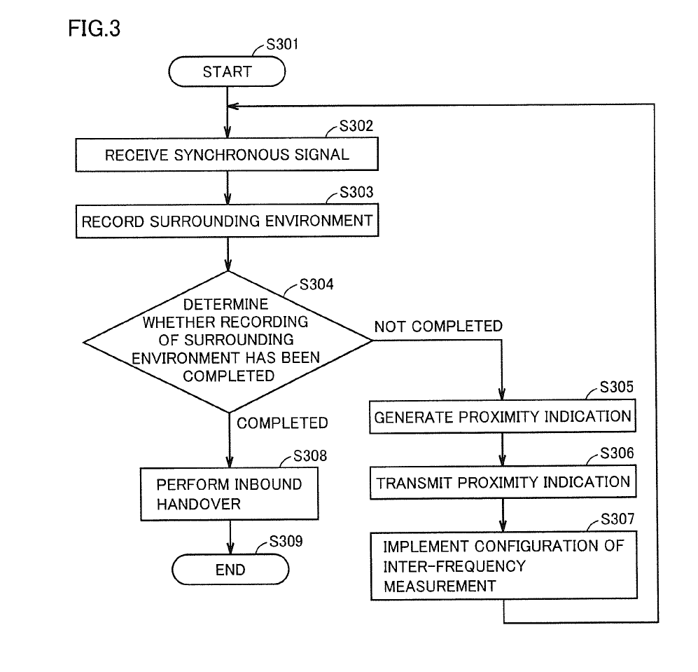

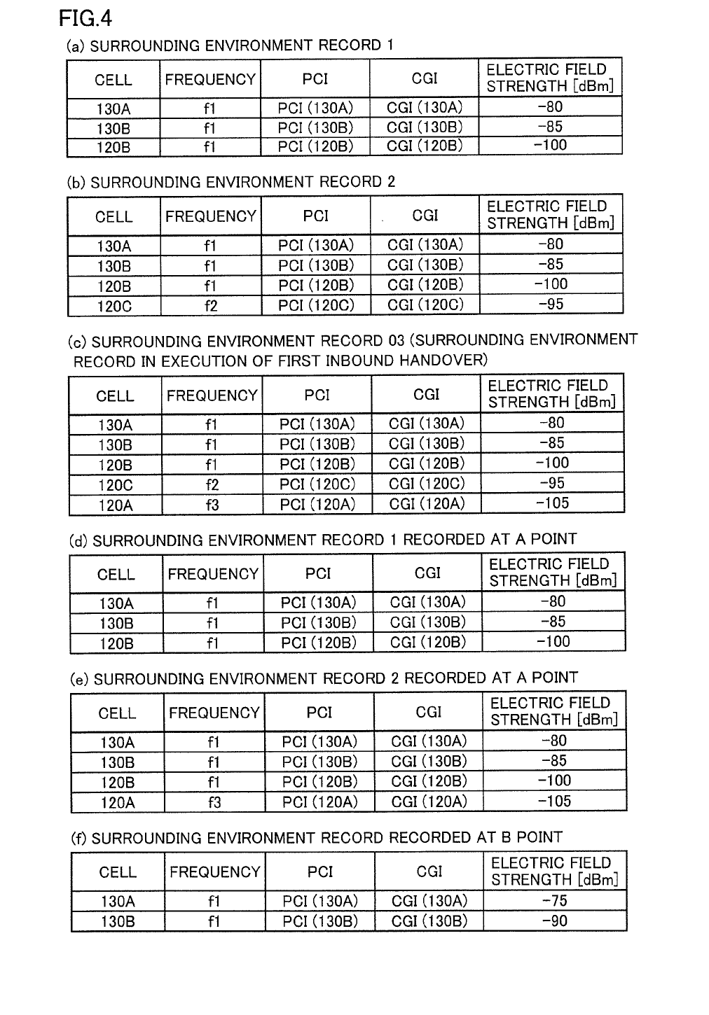

FIG. 3 is a flow diagram showing the procedure of the first inbound handover performed for the mobile station according to the first embodiment of the present invention. FIG. 4 is an example of a surrounding environment record in execution of inbound handover for the mobile station according to the first embodiment. In this example, surrounding environment records 1 to 3 in FIGS. 4(a), 4(b) and 4(c), respectively, are recorded in the process of inbound handover in accordance with the flow diagram in FIG. 3.

Referring to FIGS. 1 to 4, an explanation will be given with regard to the process at the time when the first inbound handover from macro cell base station 130A to home cell base station 120A is performed at the A point in FIG. 2.

Mobile station 110 starts recording the surrounding environment at any stage at which mobile station 110 is located in the coverage of macro cell base station 130A in FIG. 2 (step S301 in FIG. 3). First, since mobile station 110 can receive a synchronous signal and/or indication information that is output from each of macro cell base station 130B and home cell base station 120B communicating at the same frequency f1 (step S302 in FIG. 3), it reads out a PCI (Physical Cell Identity) and a CGI (Cell Global Identifier) from the received synchronous signal and measures the electric field strength to record the resultant in surrounding environment recording unit 205 in FIG. 2 (step S303). An example of the surrounding environment record recorded at this time is shown in FIG. 4(a).

In this stage, since frequency f3 of home cell base station 120A is not found (“not completed” in step S304 in FIG. 3), a proximity indication including a configuration of a different frequency is generated (step S305 in FIG. 3). When the user of mobile station 110 operates operation unit 212 to perform an operation such as configuration of a frequency, communication control unit 210 receives a signal from operation unit 212, and gives an instruction to generate a proximity indication to proximity indication generation unit 209. In addition, since the user does not know frequency f3 of home cell base station 120A at this time, a proximity indication of frequency 12 is generated. When mobile station 110 transmits a proximity indication (step S306), macro cell base station 130A transmits a configuration of inter-frequency measurement at frequency f2 to mobile station 110. When receiving and implementing a configuration of the inter-frequency measurement (step S307), mobile station 110 becomes able to receive a synchronous signal and/or indication information of frequency f2 (step S302), and records the surrounding environment of home cell base station 120C communicating at frequency f2 (step S303). An example of the surrounding environment record recorded at this time is shown in FIG. 4(b).

By comparing the recorded PCI and CGI or CSGID (Closed Subscriber Group Identity) of home cell base station 120C with the values stored in advance in the mobile station, it can be found that the base station communicating at frequency f2 is not a predetermined home cell base station 120A (“not completed” in step S304 in FIG. 3). Accordingly, the user of mobile station 110 generates a proximity indication including a configuration of a different frequency (step S305 in FIG. 3). In this case, it is assumed that a proximity indication of frequency f3 is generated. When the user transmits a proximity indication (step S306), macro cell base station 130A transmits a configuration of inter-frequency measurement at frequency f3 to mobile station 110. When implementing a configuration of the received inter-frequency measurement (step S307), mobile station 110 becomes able to receive a synchronous signal and/or indication information of frequency f3 (step S302). Then, mobile station 110 records the surrounding environment of home cell base station 120A communicating at frequency f3 (step S303). An example of the surrounding environment record recorded at this time is shown in FIG. 4(c).

In this case, by comparing the recorded PCI and CGI or CSGID with the values stored in advance in the mobile station, it can be found that the base station communicating at frequency f3 is a predetermined home cell base station 120A (“completed” in step S304 in FIG. 3), mobile station 110 undergoes inbound handover (step S308), and ends the flow (step S309).

Thus, the first inbound handover is performed, and the surrounding environment in execution of the first inbound handover, and the frequency used before and after the inbound handover and the CGI of the base station having coverage in which the mobile station is located are recorded in surrounding environment recording unit 205. Furthermore, storage of a surrounding environment record can be set as needed, for example, for 10 days, up to memory capacity of 500 M bytes, and the like. When this limit is exceeded, the stored record is set to be erased so that waste of the memory capacity can be reduced. Furthermore, the operation of mobile station 110 by the user as described above can be performed automatically or according to the instruction from the base station.

In addition, the PCI (Physical Cell Identity) is a physical cell identifier, and obtained first as an identifier identifying the base station when the mobile station searches for each base station. Typically, the PCI is obtained by the mobile station receiving a synchronous signal transmitted from the base station. The PCI is an identifier specified under LTE (Long Term Evolution), and cells having the same PCI may exist in the same PLMN (Public Land Mobile Network). Furthermore, the CGI (Cell Global Identifier) is an identifier of a base station that is included in the indication information transmitted from the base station. Since the CGI requires reception of a broadcast channel in addition to a synchronous signal, it takes more time to acquire this CGI than the case of acquiring a PCI. It is to be noted that there is no cell having the same CGI in the same PLMN. In FIG. 4, the PCI and the CGI are represented for example as a PCI (120A) and a CGI (130B), respectively, which are however merely shown schematically. PCI (120A) merely indicates a PCI of home cell base station 120A, and representation can be arbitrarily made.

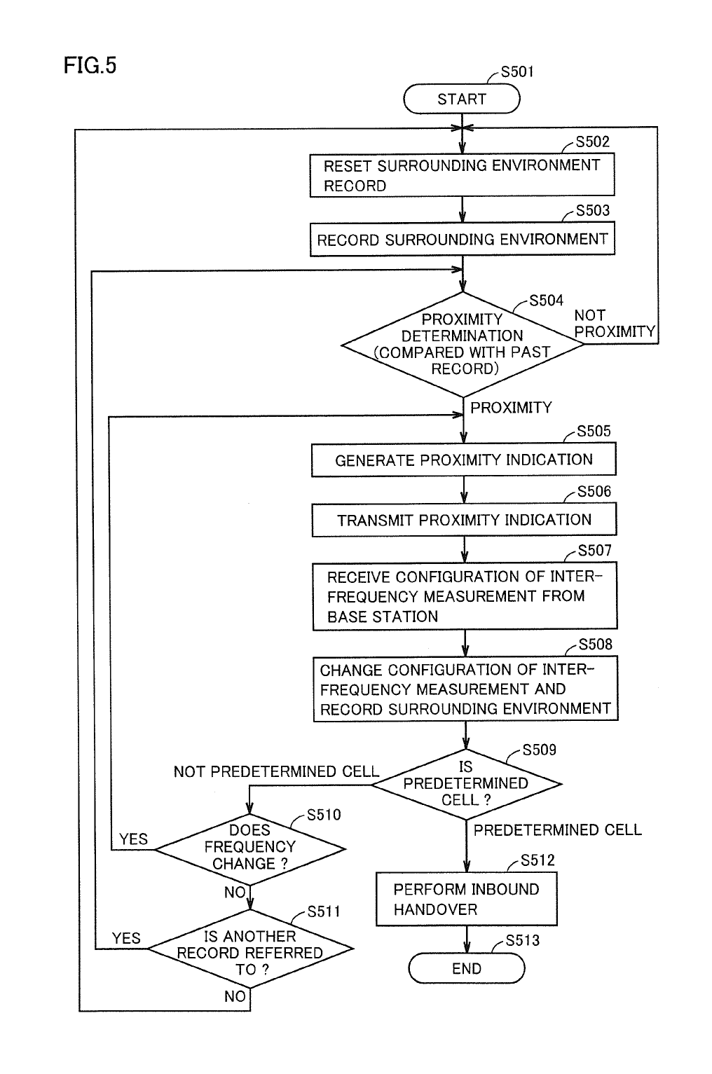

FIG. 5 is a flow diagram showing the procedure of the second and subsequent inbound handovers performed for the mobile station according to the first embodiment of the present invention. By way of example, an explanation will be given by comparing a visit to an A point in FIG. 1 and a visit to a B point in FIG. 1 by mobile station 110 while communicating with macro cell base station 130A. Although inbound handover to home cell base station 120A can be performed at the A point, inbound handover to home cell base station 120A cannot be performed at the B point since this B point is out of cell range C120A of home cell base station 120A. Mobile station 110 holds FIG. 4(c) recorded in surrounding environment recording unit 205 when the first inbound handover is performed. Furthermore, also at the second inbound handover as with the first inbound handover, the frequency used by each cell for communication is f1 in macro cell base station 130A and macro cell base station 130B, f3 in home cell base station 120A. f1 in home cell base station 120B, and f2 in home cell base station 120C. Such an assumption can be made since a communication frequency does not significantly change if the environment does not significantly change.

The case where mobile station 110 visits an A point will be described. At the start of communication or by the user's operation, mobile station 110 starts the procedure of the process in the flow diagram shown in FIG. 5 (step S501 in FIG. 5). The mobile station and the base station each perform measurement of the transmission and reception state also during communication or standby, and the flow shown in FIG. 5 is also similarly continuously performed. When the flow shown in FIG. 5 is started, mobile station 110 resets the current surrounding environment record (step S502). This does not mean erasing the past record recorded in surrounding environment recording unit 205, but means initializing the current surrounding environment record. Then, mobile station 110 newly records the current surrounding environment (step S503). In other words, since mobile station 110 communicates at frequency f1, it records the PCI and the CGI of each of macro cell base station 130A, macro cell base station 130B and home cell base station 120B, and the measured electric field strength in surrounding environment recording unit 205 at the A point. An example of the surrounding environment record recorded in surrounding environment recording unit 205 at this time is shown in FIG. 4(d).

Then, mobile station 110 performs proximity determination (step S504). Proximity determination is a process of determining whether mobile station 110 is in proximity to a predetermined home cell. Specifically, by comparing the surrounding environment record in execution of the first inbound handover stored in surrounding environment recording unit 205 with the new current surrounding environment record recorded in step S503, mobile station 110 determines whether it is in proximity to a predetermined home cell. This proximity determination is performed by proximity determination unit 208. In this case, an explanation will be given by way of example with regard to the case where the surrounding environment record in execution of the past inbound handover stored in surrounding environment recording unit 205 is a surrounding environment record in execution of the first inbound handover shown in FIG. 4(c). Proximity determination unit 208 refers to the PCI and/or the CGI in FIG. 4(d) that is a new current surrounding environment record recorded in step S503, and determines that the base stations communicating at frequency f1 are macro cell base station 130A, macro cell base station 130B and home cell base station 120B. Then, proximity determination unit 208 extracts FIG. 4(c) that is comparison data from surrounding environment recording unit 205, and similarly refer to this data. As a result of referring to FIG. 4(c), proximity determination unit 208 determines that the base stations communicating at communication frequency f1 in execution of the first inbound handover are macro cell base station 130A, macro cell base station 130B and home cell base station 120B. When comparing FIG. 4(d) with FIG. 4(c), it is found that the base stations communicating at communication frequency f1 are macro cell base station 130A, macro cell base station 130B and home cell base station 120B, and also found that FIG. 4(d) and FIG. 4(c) are identical in communication frequency. Therefore, the determination result in S504 shows that the mobile station is in “proximity” to the location where the surrounding environment record in FIG. 4(c) (information recorded when the first inbound handover was performed) is obtained. Then, the process proceeds to step S505.

In addition, although it may be determined as “proximity” only when the contents of the surrounding environment records are completely identical, it is also conceivable that, depending on the radio wave environment and the like, the contents of the surrounding environment records are not completely identical in the state where it should be determined as “proximity”. Accordingly, when comparing the surrounding environment records, the identical points and the different points are weighted, to calculate the degree of similarity between the compared surrounding environment records. Then, when this calculated degree of similarity exceeds a degree (threshold value) set in advance, it may be determined that these surrounding environment records are substantially identical. The method of calculating this degree of similarity may be set as appropriate in accordance with the items and values (range width) that can be recorded as a surrounding environment record.

In the proximity indication generation step (step S505), proximity indication generation unit 209 selects a frequency other than f1 in FIG. 4(c), and generates a proximity indication. In this case, mobile station 110 knows from the surrounding environment record in FIG. 4(c) that the frequency of predetermined home cell base station 120A is f3, and therefore, selects frequency f3. Since mobile station 110 can receive the synchronous signal and/or indication information of home cell base station 120C at frequency f3, it can perform each step of steps S506 to S508 to record the surrounding environment. An example of the surrounding environment record recorded in surrounding environment recording unit 205 at this time is shown in FIG. 4(e).

Then, mobile station 110 obtains a PCI and/or a CGI from the surrounding environment record recorded in step S508, and determines that the obtained PCI and/or CGI is the same as those/that of predetermined home cell base station 120A. Since this is the same as home cell base station 120A described in allowed CSG list of mobile station 110 (“predetermined cell” in step S509), the process proceeds to step S512, in which mobile station 110 undergoes inbound handover. Thereby, mobile station 110 disconnects communication with macro cell base station 130A, establishes communication with home cell base station 120A and ends the process (step S513). As described above, in the case where mobile station 110 visits the A point, the current surrounding environment record is compared with the surrounding environment record in execution of the first inbound handover, and the proximity indication of the frequency used by home cell base station 120A for communication that is recorded in execution of the first inbound handover is transmitted, thereby allowing execution of inbound handover. Although the above description shows an example of selecting frequency f3 from FIG. 4(c) in the proximity indication generation step (step S505), the frequency of home cell base station 120A may be changed from f3. For example, if the frequency is changed to a frequency f2, a predetermined cell cannot be found in step S509, and therefore, the process proceeds to step S510. In step S510, mobile station 110 refers to FIG. 4(c), and determines that frequency f2 that has not been examined remains. Then, when mobile station 110 selects frequency f2 in the proximity indication generation step (step S505), a predetermined cell can be found in step S509, and mobile station 110 undergoes inbound handover.

Then, the case where mobile station 110 visits a B point will be described. It is to be noted that the description similar to that of the above-described process in the case where mobile station 110 visits an A point will not be repeated. Also when visiting the B point, mobile station 110 holds the surrounding environment record in execution of the first inbound handover shown in FIG. 4(c). Also when visiting the B point, mobile station 110 starts the flow in FIG. 5 (step S501 in FIG. 5). When the flow shown in FIG. 5 is started, mobile station 110 resets the current surrounding environment record (step S502), and newly records the current surrounding environment (step S503). Mobile station 110 communicates at communication frequency f1, and can receive a synchronous signal and/or indication information output from each of macro cell base station 130A and macro cell base station 130B. Accordingly, the surrounding environment record recorded in step S503 is as shown in FIG. 4(f).

Then, mobile station 110 performs proximity determination (step S504). Proximity determination unit 208 refers to the PCI and/or the CGI in FIG. 4(f), and determines that the base stations communicating at frequency f1 are macro cell base station 130A and macro cell base station 130B. Then, proximity determination unit 208 extracts a surrounding environment record in FIG. 4(c) that is comparison data from surrounding environment recording unit 205, and also refers thereto. As a result of referring to FIG. 4(c), it is determined that the base stations communicating at communication frequency f1 in execution of the first inbound handover are macro cell base station 130A, macro cell base station 130B and home cell base station 120B. When comparing FIG. 4(f) and FIG. 4(c), it is found that the surrounding environment records of the base stations communicating at communication frequency f1 are not identical. Accordingly, the determination result in step S504 shows “not proximity” to the location where the surrounding environment record in FIG. 4(c) (information recorded when the first inbound handover was performed) is obtained, and then, the process proceeds to step S502. Mobile station 110 resets the surrounding environment record, and records the surrounding environment again.

Thus, inbound handover is not performed when mobile station 110 visits the B point. In addition, since only the same results are obtained even by recording at the same B point again, the surrounding environment may be recorded again only when mobile station 110 moves or only when the surrounding environment such as a radio wave condition is changed.

The step in the flow diagram in FIG. 5 that has not been described, that is, step S511, will then be described. In the above-described example, only those shown in FIG. 4(c) are assumed to be the surrounding environment record in execution of the first inbound handover recorded in surrounding environment recording unit 205. However, a plurality of surrounding environment records in execution of inbound handover may be recorded in surrounding environment recording unit 205. For example, in the state where a home cell base station installed in the station premises and in the position where the user frequently visits is recorded in allowed CSG list 204 in addition to a home cell base station for household, inbound handover is performed. Step S511 is for addressing such a situation, in which mobile station 110 sequentially refers to a plurality of surrounding environment records in step S511, compares the past surrounding environment record with the current surrounding environment record as in the case described above, to perform proximity determination, and then, undergoes inbound handover.

Since it cannot be determined in the above-described related art that mobile station 110 cannot be connected to home cell base station 120A at the B point, mobile station 110 has to transmit a proximity indication while changing a frequency until this frequency is equal to the communication frequency of home cell base station 120A. Furthermore, at the A point, mobile station 110 can be connected to home cell base station 120A even by the related art, which however causes inconvenience since transmission of the proximity indication is increased or the user has to manually make configuration, and the like. By employing such a configuration as in the first embodiment, it becomes possible to prevent transmission of a proximity indication at the B point where mobile station 110 cannot be connected to a predetermined home cell, also possible to reduce transmission of a proximity indication at the A point. Accordingly, load to a communications system can be reduced while the electric power consumed by mobile station 110 can also be reduced.

In the above description, although the PCI and/or CGI are/is used for comparison between the current surrounding environment record and the past surrounding environment record for performing proximity determination, it is also possible to select the information to be used depending on whether the comparison time or the proximity determination accuracy is regarded as important. When making a comparison only using the PCI, inbound handover to a cell having coverage in which mobile station 110 cannot be located may be performed since there may be a plurality of cells having the same PCI in the same PLMN. This can be addressed by performing inbound handover sequentially to the cells to which inbound handover is not performed or by performing proximity determination by using the CGI to perform inbound handover, which however may cause needless transmission of a proximity indication or may cause a needless proximity determination. When making a comparison only by using the CGI, re-execution of inbound handover does not occur as in the case of the PCI. However, since it is necessary to receive a broadcast channel in addition to a synchronous signal, proximity determination may take time. In the present embodiment, proximity determination may be performed by using the CGI when accuracy is regarded as important, or proximity determination may be performed by using the PCI when the connection time is regarded as important, which can be chosen by the user's operation, by control from the base station, or by the mobile station automatically. For example, when the mobile station moves at higher speed, the base station may detect the moving speed of the mobile station and gives an instruction to perform proximity determination by using the PCI, or the mobile station equipped with a speed sensor may detect its own moving speed and perform proximity determination by using the PCI.

Furthermore, in the present embodiment, in addition to a PCI and a CGI, electric field strength is also measured as shown in FIG. 4. Since the electric field strength shows a constant value to some extent at the same position, proximity determination can be performed by using the electric field strength. However, the electric field strength may be influenced by the weather or may differ depending on the measuring time. Accordingly, when using the electric field strength for determination, comparison may be performed not by determination using an absolute value but depending on whether the electric field strength falls within a fixed range. Furthermore, since stable communication cannot be expected when the electric field strength is too low due to the natural environment or conditions on the base station side or the mobile station side, inbound handover may be prevented from being performed. It is to be noted that all of the PCI, the CGI and the electric field strength does not have to be recorded by surrounding environment recording unit 205, but may be selectively recorded thereby.

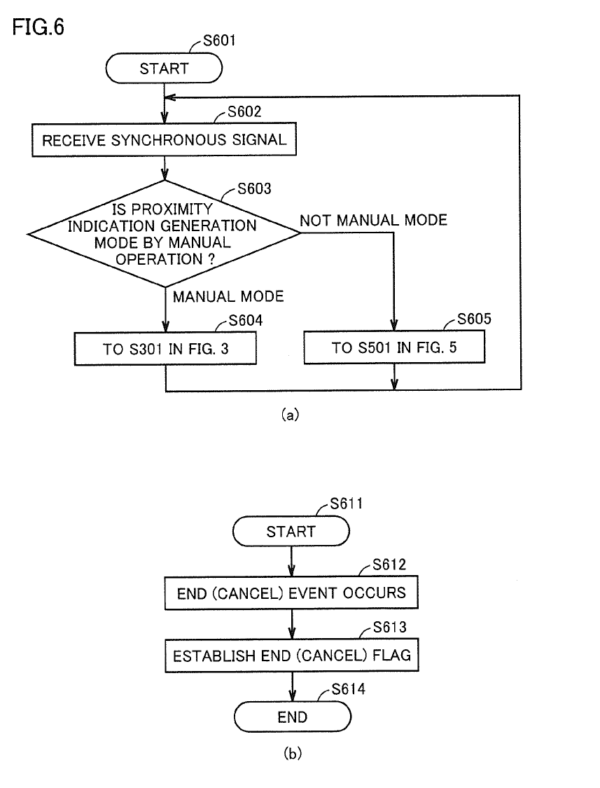

FIG. 6 is a flow diagram showing the procedure related to selection between the first inbound handover process and the second and subsequent inbound handover processes performed for the mobile station according to the first embodiment of the present invention. Referring to FIG. 6, when the power supply of mobile station 110 is turned on in step S601 in FIG. 6(a), the process is started from step S601 in the flow diagram in FIG. 6(a). When receiving a synchronous signal transmitted from the base station in step S602, mobile station 110 establishes communication with the base station. In this case, when mobile station 110 goes into a proximity indication generation mode by the user's manual operation, the mode goes into a “manual mode” in step S603. Then, the process proceeds to “S301 in FIG. 3” in step S604, in which the first inbound handover as described above is performed in step S604 (step S604). When the process in step S604 is ended, the process returns to step S602. Since inbound handover has been completed in this case, mobile station 110 may be located in the coverage of a home cell, or mobile station 110 may end the communication with a home cell and communicate with a macro cell. Since this point is a substantial part of the present embodiment, details description thereof will not be given.

In contrast, when mobile station 110 does not go into a proximity indication generation mode by the user's manual operation, the mode goes into a “manual mode” in step S603. Then, the process proceeds to “S501 in FIG. 5” in step S605, in which the second and subsequent inbound handovers as described above are performed in step S605 (step S605). When the process in step S605 is ended, it returns to step S602. Since inbound handover has been completed also in this case, mobile station 110 may be located in the coverage of the home cell, or may end the communication with the home cell and communicate with the macro cell.

Furthermore, in mobile station 110 according to the first embodiment, the process shown in the end flow in FIG. 6(b) is constantly performed in asynchronous with FIG. 6(a) (“start” shown in step S611). Thereby, when the power supply is turned off by the user's operation, running out of battery and the like, or when the operation is stopped in the middle thereof (“end (cancel) event occurs” in step S612), an end flag is established and the ending process set in advance is performed (“establish end (cancel) flag” in step S613). Then, the process shown in the flow in FIG. 6(a) is ended (“end” in step S614). The ending process set in advance may be as follows: For example, when the stopping process is performed in execution of inbound handover in the flow in FIG. 3 or 5, the surrounding environment record is stored and the process is ended. When the inbound handover process is not started, for example, when the stopping process is performed in execution of the step in step S306 or S505, the surrounding environment record recorded in step S303 or S502 is erased in order to avoid needless consumption of the memory, and the process is ended.

As described above, in the first embodiment, surrounding environment recording unit 205 and proximity determination unit 208 are provided in mobile station 110, the surrounding environment in execution of the first inbound handover is recorded in surrounding environment recording unit 205, and the recorded surrounding environment record in execution of the first inbound handover is compared with the surrounding environment record of the second inbound handover, to perform proximity determination, thereby efficiently performing the second inbound handover. When performing the third and subsequent inbound handovers, the surrounding environment record previously recorded in surrounding environment recording unit 205 is compared with the current surrounding environment record (in execution of the third and subsequent inbound handovers) to perform proximity determination, thereby efficiently performing the third and subsequent inbound handovers.

When performing the first inbound handover, for example, such as after the location visited for the first time and memory are reset, transmission of a proximity indication occurs in a similar frequency to that in the case of the above-described related art, but transmission of a proximity indication can be limited after the second and subsequent inbound handovers. Consequently, since transmission of a proximity indication can be reduced, it becomes possible to reduce electric power consumed by the mobile station and avoid deterioration in communication performance of the entire communications system. Furthermore, since the second and subsequent inbound handovers are automatically performed, convenience is also improved.

### Second Embodiment

In the second embodiment, mobile station 110 records, in in-cell-coverage history recording unit 206, the history of a cell having coverage in which a mobile station is located that is obtained at the time when inbound handover is performed, and utilizes this history afterward, thereby efficiently transmitting a proximity indication. The configuration of mobile station 110 is the same as that in FIG. 1, and recording of the surrounding environment, transmission of a proximity indication, the mechanism and procedure about inbound handover, the way to handle the PCI, CGI and electric field strength are the same as those described in the first embodiment, and therefore, detailed description thereof will not be repeated. In the following, parts related to the second embodiment will be mainly described. In the second embodiment, the information about predetermined home cell base station 210A is recorded in allowed CSG list 204 of USIM 203 in mobile station 110. The user of mobile station 110 expects that, when coming close to home cell base station 210A, inbound handover is performed to communicate with home cell base station 210A.

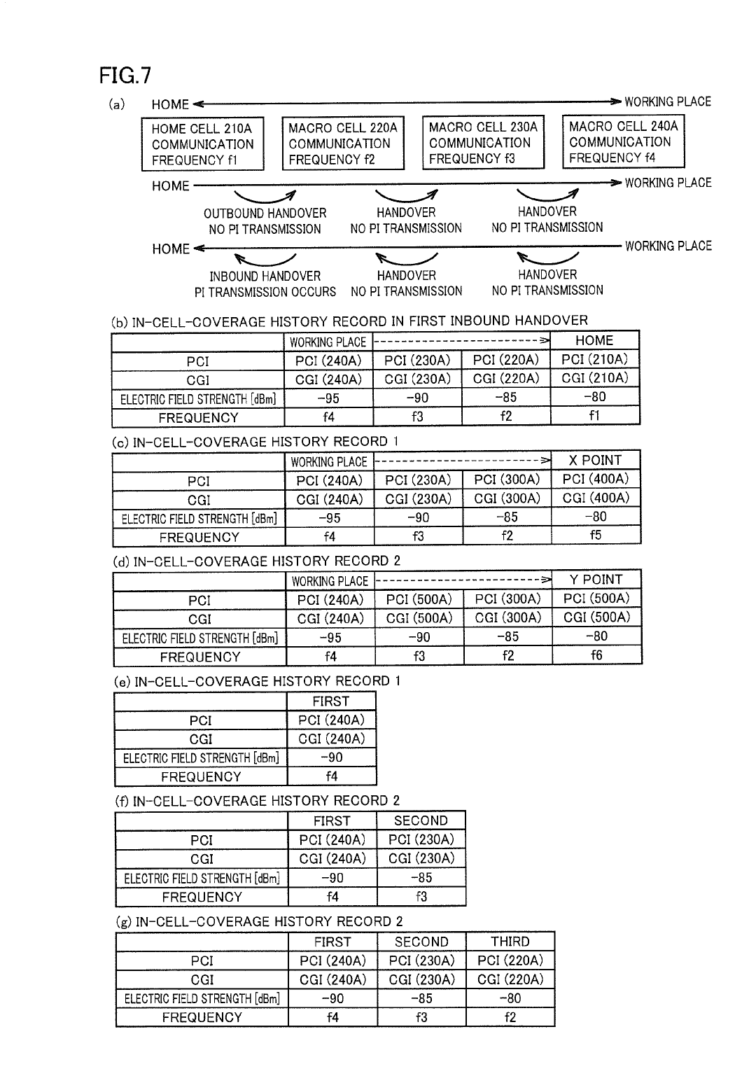

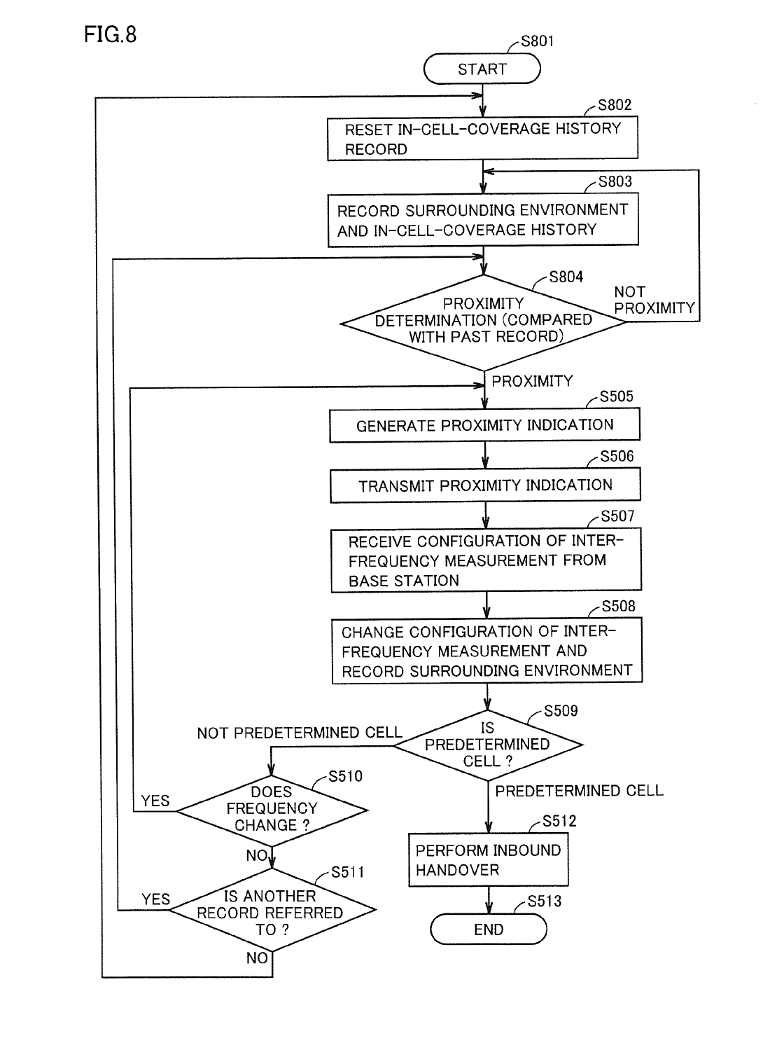

Referring to FIGS. 7 and 8, the second embodiment will be described. FIG. 7(a) shows each cell having coverage in which mobile station 110 is located and the state of handover in the case where the user of mobile station 110 travels back and forth between home and work. FIG. 7(b) shows an example of the in-cell-coverage history record recorded in in-cell-coverage history recording unit 206 that is obtained by the first inbound handover performed when the user goes from work to home in the back-and-forth movement shown in FIG. 7(a). In this case, the communication frequency of a home cell base station 210A is f1; the frequency of a macro cell base station 220A is f2; the frequency of a macro cell base station 230A is f3; and the frequency of a macro cell base station 240A is f4.

When mobile station 110 goes from home to work, handover is performed from home cell base station 210A, to macro cell base station 220A, to macro cell base station 230A, and to macro cell base station 240A in this order, in which case mobile station 110 is located in the coverage of each base station. In this case, since inbound handover is not performed as described in the first embodiment, mobile station 110 does not transmit a proximity indication.

When mobile station 110 goes from work to home, handover from macro cell base station 220A to home cell base station 210A is performed as inbound handover. Accordingly, mobile station 110 transmits a proximity indication. In addition, since home cell base station 210A communicates at a frequency different from that of mobile station 110 that is located in the coverage of macro cell base station 220A, the process such as transmission of a proximity indication is performed by the operation of the user of mobile station 110 as in the case of the first embodiment, inbound handover is performed. In this case, mobile station 110 records an in-cell-coverage history as shown in FIG. 7(b) in in-cell-coverage history recording unit 206. In addition, for recording in in-cell-coverage history recording unit 206, the number of cells to be recorded is determined as four, for examples. Thus, if inbound handover is performed at the fourth cell, the in-cell-coverage histories up to the fourth cell are recorded in in-cell-coverage history recording unit 206. If inbound handover is not performed at the fourth cell, the first in-cell-coverage history may be erased and the next inbound handover may be waited, and thus, the contents of in-cell-coverage history recording unit 206 may be updated and recorded at the appropriate times. Alternatively, in-cell-coverage history is stored in surrounding environment recording unit 205 together with the surrounding environment record. Then, when inbound handover is performed, records of the past three inbound handovers stored in surrounding environment recording unit 205 may be extracted and recorded in in-cell-coverage history recording unit 206 together with the PCI, the CGI and the like of the cell subjected to inbound handover.

Then, execution of the second and subsequent inbound handovers will be described. Usually, mobile station 110 records, in in-cell-coverage history recording unit 206, not only the in-cell-coverage history in execution of inbound handover at the time when the user goes from work to home as shown in FIG. 7(a) but also the in-cell-coverage history at the time of movement other than the above. Assuming such a situation occurs, an explanation will be given with regard to the manner in which the second and subsequent inbound handovers are performed for mobile station 110 in the state where in-cell-coverage history recording unit 206 stores the in-cell-coverage history record in execution of the first inbound handover as shown in FIG. 7(b) and, for example, an in-cell-coverage history record 1 as shown in FIG. 7(c) and an in-cell-coverage history record 2 as shown in FIG. 7(d).

FIG. 8 is a flow diagram showing the procedure of the second and subsequent inbound handovers performed for the mobile station according to the second embodiment of the present invention. In the flow diagram shown in FIG. 8, the same step number is allocated to the same process as that in the flow diagram shown in FIG. 5. The process different from that in the flow diagram shown in FIG. 5 will be mainly hereinafter described. More specifically, the flow diagram shown in FIG. 8 is different from the first embodiment in that not only the surrounding environment but also the in-cell-coverage history is recorded. Accordingly, details of the process in steps S802, S803 and S804 are different from those of the process in step S502, S503 and S504 shown in FIG. 5.

At the time when mobile station 110 is located at the working place, it is located in the coverage of macro cell base station 240A. At this time, mobile station 110 resets the in-cell-coverage history record in step S802 of the flow diagram in FIG. 8, and in step S803, measures the record of the surroundings to obtain a PCI and a CGI, and records the in-cell-coverage history record as shown in FIG. 7(e) in in-cell-coverage history recording unit 206. In step S804, proximity determination unit 208 compares the in-cell-coverage history record shown in FIG. 7(e) with the in-cell-coverage history record shown in each of FIGS. 7(b), 7(c) and 7(d) to perform proximity determination. In this case, since all values of the PCI and the CGI corresponding to the “company” in the first column in the in-cell-coverage history record in each of FIGS. 7(b), 7(c) and 7(d) are the same as those in the case of macro cell base station 240A, and therefore, cannot be selected. Accordingly, it is determined as “not proximity” and the process returns to step S803.

When mobile station 110 moves and handover is performed from macro cell base station 240A to macro cell base station 230A in FIG. 7(a), mobile station 110 records the surrounding environment (step S803). An example of the in-cell-coverage history record at this time is shown in FIG. 7(f). In the in-cell-coverage history in FIG. 7(f), the information of macro cell base station 230A is additionally recorded in the second column, as compared with the in-cell-coverage history in FIG. 7(e). Step S804 is performed again, and proximity determination unit 208 compares the information of macro cell base station 230A in the second column included in the in-cell-coverage history record shown in FIG. 7(f) with the information in the second column in the in-cell-coverage history record in each of FIGS. 7(b), 7(c) and 7(d), to perform proximity determination. In this case, the second column in the in-cell-coverage history record in FIG. 7(d) shows the information about a macro cell 500A, and therefore, is not identical to the information of macro cell base station 230A in the second column in the in-cell-coverage history record in FIG. 7(f), and thus, excluded from candidates for proximity determination. In contrast, since the second column in in-cell-coverage history record in FIG. 7(d) is identical to the information of macro cell base station 230A in the second column in the in-cell-coverage history record in each of FIGS. 7(b) and 7(c), it is again determined as “not proximity”, and the process returns to step S803.

When mobile station 110 further moves and handover to macro cell base station 220A in FIG. 7(a) is performed, mobile station 110 records a surrounding environment. An example of the in-cell-coverage history record at this time is shown in FIG. 7(g). In the in-cell-coverage history in FIG. 7(g), the information of macro cell base station 220A is additionally recorded in the third column, as compared with the in-cell-coverage history record in FIG. 7(f). Step S804 is performed again, and proximity determination unit 208 compares the information of macro cell base station 220A in the third column included in the in-cell-coverage history record shown in FIG. 7(g) with the information in the third column in the in-cell-coverage history record in each of FIGS. 7(b) and 7(c), to perform proximity determination. The third column in the in-cell-coverage history record in FIG. 7(c) shows the information of a macro cell 300A, and is different from the information of 220A in the third column in the in-cell-coverage history record in FIG. 7(g). Consequently, candidates are narrowed down to the in-cell-coverage history record in FIG. 7(b), and it is determined as “proximity” in step S804. Then, the process proceeds to step S505.

In step S505, proximity indication generation unit 209 generates a proximity indication for giving an instruction to transmit, to mobile station 110, the configuration of inter-frequency measurement at frequency f1 of home cell base station 210A of “home” in the fourth column in the in-cell-coverage history record in FIG. 7(b). Mobile station 110 transmits a proximity indication to macro cell base station 220A in step S506. Mobile station 110 receives a configuration of the inter-frequency measurement at frequency f1 in the step of step S507, implements the configuration, receives a synchronous signal and/or indication information of home cell base station 210A, and records a surrounding environment (step S509). Consequently, since mobile station 110 obtains a PCI and/or a CGI and determines that the cell recorded in step S508 is a predetermined cell (“predetermined cell” in step S509), inbound handover is performed (step S512), and then, the flow is ended. In addition, in the process in step S508, it is conceivable that mobile station 110 may be located out of the communication range of home cell base station 210A though it is located in the coverage of macro cell base station 220A. Accordingly, the process in step S508 may be re-executed periodically every time a preset time period elapses.

As described above, in the second embodiment, in-cell-coverage history recording unit 206 is provided in mobile station 110, the in-cell-coverage history in execution of the first inbound handover is recorded in in-cell-coverage history recording unit 206, and the recorded in-cell-coverage history in execution of the first inbound handover is compared with the in-cell-coverage history in the second and subsequent inbound handovers, to perform proximity determination, thereby efficiently performing the second and subsequent inbound handovers.

In the case where an environment is fixed to some extent, for example, such as travelling back and forth between home and work, the arrangement of a home cell communicating at a different frequency, for example, a home cell base station for household in a house or an apartment house, a local base station in station premises and the like is also fixed to some extent. Accordingly, once the operation of recording an in-cell-coverage history is performed, connection can be automatically established from the next time, which is therefore convenient. Furthermore, as to comparison of the in-cell-coverage histories, surrounding environments are compared in a sequential manner, unlike the first embodiment. Accordingly, since candidates are narrowed to some extent from the in-cell-coverage history records stored until the mobile station comes close to a predetermined home cell, connection can be established immediately after the mobile station comes in the coverage of the home cell. Consequently, when mobile station 110 moves at high speed by automobile or the like, connection can be established in a relatively short period of time. Furthermore, the number of cells recorded in in-cell-coverage history recording unit 206 may be different from the number of cells to be compared. In other words, even if the number of cells in the in-cell-coverage history in execution of the first inbound handover is five and the number of cells in the current in-cell-coverage history is three, proximity determination can be performed by extracting and comparing subsets among the five cells.

<Modification>

The above-described first embodiment and second embodiment may be combined as appropriate to perform proximity determination. For example, when the proximity determination according to the second embodiment is set as the first stage determination and the proximity determination according to the first embodiment is set as the second stage determination, it becomes possible to provide a wireless communication system that allows more accurate proximity indication transmission.

In addition, the program for implementing a wireless communication system according to the first and second embodiments may be recorded in a non-transitory computer-readable recording medium, and this program recorded in the non-transitory recording medium may be read into a computer system and executed, thereby implementing the wireless communication system. A “computer system” may include hardware such as an OS, a peripheral device and the like. Furthermore, a “non-transitory computer-readable recording medium” includes a portable medium such as a flexible disk, a magneto-optical disc, a ROM and a CD-ROM, and a storage device such as hard disk incorporated in a computer system. Furthermore, a “non-transitory computer-readable recording medium” may include such a medium that holds a program for a certain period of time, like a volatile memory (RAM) within a computer system serving as a server or a client in the case where a program is transmitted through a network such as the Internet or through a communication line such as a telephone line.

The above-described program may be transmitted from a computer system having a storage device and the like storing this program through a transmission medium or via a transmission wave within the transmission medium to another computer system. The “transmission medium” used herein and transmitting a program means a medium having a function of transmitting information like a network (communication network) such as the Internet or a communication link (communication line) such as a telephone line. Furthermore, the above-described program may be for implementing a part of the function described above. Furthermore, the above-described program can implement the above-described function by a combination with the program already recorded in the computer system, that is, a difference file (difference program).

Although the embodiments of the present invention have been described in detail with reference to the accompanying drawings, a specific configuration is not limited to these embodiments, but may include a design modification within the scope without deviating from the intention of the present invention.

### REFERENCE SIGNS LIST

110, 902 mobile station, 120A, 120B, 120C, 210A, 901 home cell base station, 130A, 130B, 220A, 230A, 240A, 900 macro cell base station, 201 antenna unit, 202 reception unit, 204 allowed CSG list, 205 surrounding environment recording unit, 206 in-cell-coverage history recording unit, 207 transmission unit, 208 proximity determination unit, 209 proximity indication generation unit, 210 communication control unit, 211 application unit. 212 operation unit, 213 storage unit, 300A, 500A macro cell.

1. A mobile station connected to a wireless communication network, the mobile station comprising:
surrounding environment recording unit configured to record a surrounding environment of the mobile station;
proximity determining unit configured to determine whether the mobile station is in proximity to a predetermined base station; and
proximity indication generating unit configured to generate a proximity indication,
the proximity determining unit being adapted to
compare a past surrounding environment record that has been recorded by the surrounding environment recording unit with a current surrounding environment record,
determine that the mobile station is in proximity to a predetermined home cell base station when the surrounding environment records correspond to each other, or when a degree of similarity between the surrounding environment records exceeds a predetermined degree, and
transmit the proximity indication generated by the proximity indication generating unit to a macro cell base station in response to determination that the mobile station is in proximity to the predetermined home cell base station.

2. A mobile station connected to a communication network in which both a macro cell base station and a home cell base station exist, the mobile station comprising:
surrounding environment recording unit configured to record a surrounding environment of the mobile station;
in-cell-coverage history recording unit configured to record a history of a macro cell base station and a home cell base station each having coverage in which the mobile station was/is located;
proximity determining unit configured to determine whether the mobile station is in proximity to a predetermined home cell base station; and
proximity indication generating unit configured to generate a proximity indication,
the proximity determining unit being adapted to
compare a past in-cell-coverage history and a past surrounding environment record in execution of inbound handover that have been recorded by the in-cell-coverage history recording unit and the surrounding environment recording unit, with a current in-cell-coverage history and a current surrounding environment record, respectively,
determine that the mobile station is in proximity to the predetermined home cell base station when the in-cell-coverage histories correspond to each other and the surrounding environment records correspond to each other, and
transmit the proximity indication generated by the proximity indication generating unit to the macro cell base station in response to determination that the mobile station is in proximity to the predetermined home cell base station.

3. The mobile station according to claim 1, wherein the surrounding environment record includes at least one selected from a PCI (Physical Cell Identity), a CGI (Cell Global Identifier), electric field strength, and a frequency.

4. The mobile station according to claim 3, wherein when the electric field strength is lower than pre-set strength, the proximity determining unit stops transmission of the proximity indication.

5. The mobile station according to claim 2, wherein the in-cell-coverage history includes a receiving history of a synchronous signal and/or indication information.

6. The mobile station according to claim 2, wherein the proximity determining unit compares the in-cell-coverage histories using a part or all of one or more cells recorded by the in-cell-coverage history recording unit.

7. The mobile station according to claim 2, wherein the surrounding environment record includes at least one selected from a PCI (Physical Cell Identity), a CGI (Cell Global Identifier), electric field strength, and a frequency,
